(19) United States
(12) Patent Application Publication
(10) Pub. No.: US 2003/0044255 A1
(43) Pub. Date: Mar. 6, 2003

(54) Fastening device for a wheel

(76) Inventor: Joong-Min Park, Kyungki-do (KR)

Correspondence Address: Pennie & Edmonds, LLP, 3300 Hillview Avenue, Palo Alto, CA, 94304, US

(21) Appl. No.: 10/224,870

(22) Filed: Aug. 20, 2002

(30) Foreign Application Priority Data
Sep. 4, 2001 (KR) 2001-54020

(51) Int. Cl. F16B 39/04

(52) U.S. Cl. 411/318

(57) ABSTRACT

A fastening device for a wheel is disclosed. A hub nut which has been fastened to a hub bolt cannot be loosened owing to a decoupling prevention unit of the hub nut and a rotation prevention protuberance of the hub bolt, as long as an assembling tool is not used. Consequently, the fastening device improves the steering stability of an automobile and prevents separation of the wheels from the axles while the vehicle is in motion.

### FIELD OF THE INVENTION

The present invention relates to a fastening device for a wheel, and more particularly, to a fastening device for a wheel in which the coupling forces between the hub bolts and the hub nuts are improved, thereby preventing separation of the wheel from the vehicular axle while the vehicle is in motion.

### BACKGROUND OF THE INVENTION

A conventional automobile wheel consists of a disc wheel and a tire fitted to the disc wheel so as to be rotated with the disc wheel. The wheel is fastened to a wheel hub by using hub bolts and hub nuts. The hub is coupled to the vehicular axle. The hub bolts pass through the disc wheel. The hub nuts are fastened to the ends of the hub bolts, thereby coupling the wheel to the wheel hub. If the hub bolts and the hub nuts are to be fastened together or unfastened from each other, an assembling tool such as a wrench is used.

However, conventional hub bolts and hub nuts are coupled together only by the threads. Accordingly, if the hub bolts and hub nuts are not fastened properly, the coupling force between the wheel and the wheel hub becomes loose, and steering stability is degraded while the vehicle is in motion, or the wheel may be separated from the wheel hub, potentially causing injury to occupants and damage to the vehicle.

### SUMMARY OF THE INVENTION

The present invention provides a fastening device for a wheel that prevents deterioration of the steering stability and separation of the wheel from the vehicular axle, even if the hub bolts and the hub nuts are loosely fastened, thereby preventing injury to occupants and damage to the vehicle.

In accordance with an embodiment of the present invention, a hub bolt passes through a wheel hub and a disc wheel to couple with the hub nut. A rotation prevention protuberance is formed integrally on the leading end of the hub bolt with a predetermined length. A decoupling prevention means is elastically and pivotally installed in the hub nut so as to selectively interact with the rotation prevention protuberance and prevent any unintended decoupling of the hub bolt and the hub nut.

In an alternative preferred embodiment, a bolt has a protuberance extending from one end and a nut is configured to be threaded over said bolt. The nut includes a bracket configured and dimensioned to be received over said protuberance and lock thereon. Preferably, an elastic member acts on the bracket to bias it over the protuberance when the nut is threaded on the bolt such that the nut is locked on the bolt by the bracket. Further preferably, the bracket is pivotably mounted within the nut such that one end extends beyond a peripheral surface of the nut when biased over the protuberance. The bracket is further configured to be pivoted by placement of a tool over the nut such that the bracket is disengaged from the protuberance, whereby the nut is unlocked from the bolt.

### BRIEF DESCRIPTION OF THE DRAWINGS

For fuller understanding of the nature and objects of the invention, reference should be made to the following detailed description taken in conjunction with the accompanying drawings in which:

FIG. 1 is a side view of a hub bolt and nut according to an embodiment of the invention;

FIG. 2 is a perspective view of a hub nut according to the invention;

FIG. 3. is a side view of a decoupling prevention means installed on a hub nut of the present invention;

FIG. 4 is a schematic view with an enlarged view portion illustrating use of a tool on the hub nut of the invention; and

FIG. 5 is a view similar to FIG. 4 without the tool.

### DETAILED DESCRIPTION OF THE PREFERRED EMBODIMENT

The present invention will be described in detail referring to the attached drawings.

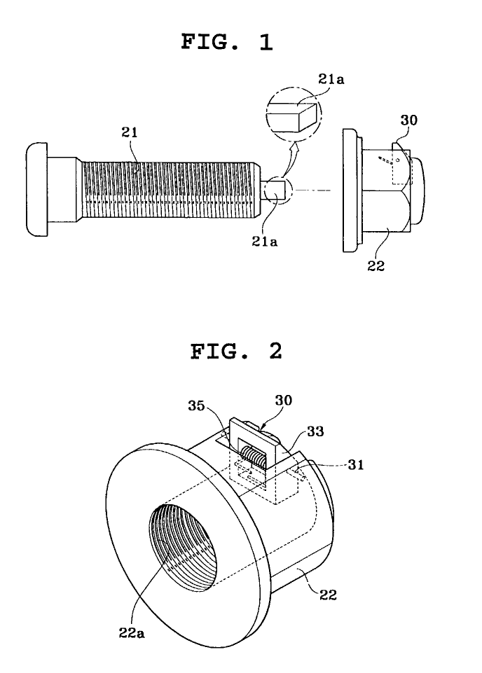

As shown in FIG. 1, a rotation prevention protuberance 21 a with a predetermined length is formed on the leading end of the hub bolt 21. Hub nut 22 is provided with a decoupling prevention means 30, which selectively interacts with the rotation prevention protuberance 21 a so as to make it impossible to rotate the hub nut 22 without using an appropriate assembling tool T. The protuberance 21 a is preferably formed in the shape of an angular pole such as a tetragonal pole or a hexagonal pole. The reason for the angular shape is so that when the hub bolt 21 and the hub nut 22 are fastened together, the decoupling prevention means 30 will cause an interference and effectively prevent any unintended rotation of the hub nut 22.

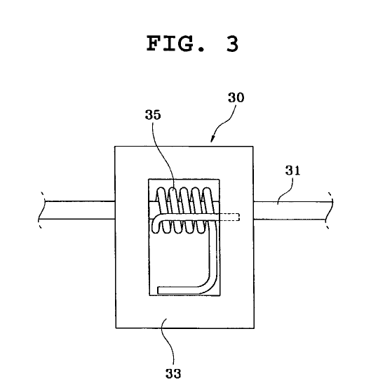

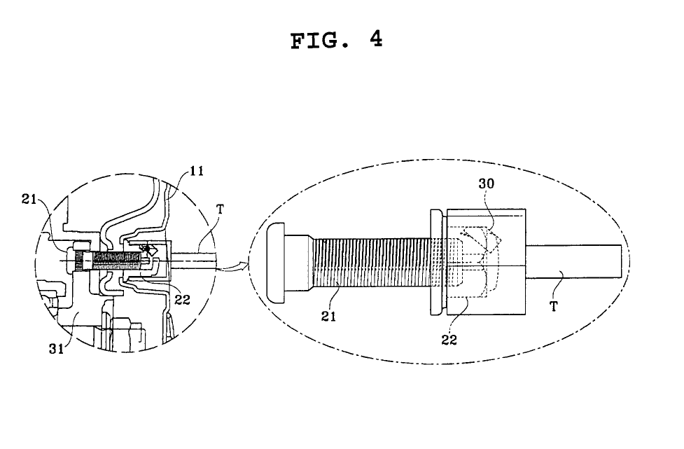

As shown in FIGS. 2 and 3, the decoupling prevention means 30 includes a rotation shaft 31 with its both ends secured in the hub nut 22 in a direction crossing the axis of the hub bolt 21. A pivotal bracket 33 is pivotally installed on the rotation shaft 31, with one end of the pivotal bracket 33 projecting out of the hub nut and the other end of the pivotal bracket 33 extending inwardly beyond the inner circumference of the hub nut. When the assembling tool T is fitted onto the hub nut 22 (see, e.g., FIG. 4), the pivotal bracket 33 is rotated in one direction (counter clockwise direction) so that its two ends are rotated toward the body of the hub nut 22. An elastic member 35 is installed between the rotation shaft 31 and the pivotal bracket 33, for elastically forcing the other end of the pivotal bracket 33 inwardly. When the assembling tool T is not fitted to the hub nut 22, one end of the pivotal bracket 33 projects out of the hub nut 22, while the other end is buried inwardly beyond the inner circumference of the hub nut 22.

When the assembling tool T is fitted to the hub nut 22 by overcoming the elastic force of the elastic member 35, then the other end of the pivotal bracket 33 withdraws outwardly, and therefore, the rotation prevention protuberance 21a of the hub bolt 21 can be freely rotated within the hub nut 22. When the assembling tool T is removed, the other end of the pivotal bracket 33 is pivoted inwardly (beyond the inner circumference of the hub nut 22) owing to the elastic force of the elastic member 35. Pivotal bracket 33 comes to interact with the rotation prevention protuberance 21 a of the hub bolt 21. The elastic member 35 may consist of a torsion spring.

In a state where the hub bolt 21 is inserted into the wheel (which has been closely attached to the wheel hub 51), if an assembling tool T is used to fasten the hub nut 22 with the hub bolt 21, then the pivotal bracket 33 of the decoupling prevention means 30 is pivoted in counter clockwise direction by the assembling tool T as shown in FIG. 4. Thus, the other end of the pivotal bracket 33, which projects inwardly toward the inner circumference of the hub nut 22, is rotated toward the outer circumference of the hub nut 22 and does not interact with the rotation prevention protuberance 21a of the hub bolt 21. Under this condition, the assembling tool T can be rotated in one direction to fasten the hub nut 22 to the hub bolt 21.

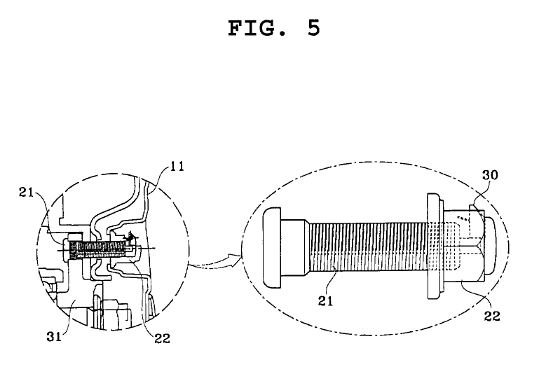

After completion of the fastening of the hub nut 22 to the hub bolt 21, the assembling tool T is removed from the hub nut 22. The pivotal bracket 33 of the decoupling prevention means 30 is restored to its original position due to the elastic force of the elastic member 35 as shown in FIG. 5. As a result, the other end of the pivotal bracket 33 protrudes inwardly beyond the inner circumference of the hub nut 22 to interact with the rotation prevention protuberance 21 a of the hub bolt 21, so that the hub nut 22 can be prevented from being separated from the hub bolt 21.

Hub nut 22 is not loosened from the hub bolt 21 by itself, but if the assembling tool T is used, the pivotal bracket 33 is pivoted to release the interaction between the pivotal bracket 33 and the rotation prevention protuberance 21a. Hence, the hub nut 22 can easily be unfastened like a conventional hub nut.

According to the present invention as described above, as long as the assembling tool is not used, the hub nuts should not loosen from the hub bolts, owing to the rotation prevention protuberance of the hub bolt and the decoupling prevention means of the hub nut. Therefore, separation of the wheels from the wheel hubs while the vehicle is in motion may be reduced or avoided, lessening the possibility of injury to occupants and damage to the vehicle.

What is claimed is:

1. A fastening device for a wheel, comprising:
a rotation prevention protuberance formed on a leading end of a hub bolt; and
a decoupling prevention means installed in a hub nut, for selectively interacting with the rotation prevention protuberance of the hub bolt.

2. The fastening device as claimed in claim 1, wherein said rotation prevention protuberance is shaped in the form of an at least six-sided angular pole.

3. The fastening device as claimed in claim 1, wherein the decoupling prevention means comprises;
a rotation shaft disposed in a direction crossing an axis of said hub bolt with both ends thereof being secured in said hub nut;
a pivotal bracket fixed on the rotation shaft in a pivotal form, with one end thereof projecting out of said hub nut and the other end thereof being directed inwardly beyond an inner circumference of said hub nut, and the other end withdrawing outward from the inner circumference of said hub nut upon fitting the assembling tool on said hub nut; and
an elastic member installed between said rotation shaft and said pivotal bracket, for elastically pushing the other end of said pivotal bracket inwardly beyond the inner circumference of said hub nut.

4. A fastening device, comprising:
a bolt having a protuberance extending from one end; and
a nut configured to be threaded over said bolt and including a bracket configured and dimensioned to be received over said protuberance and lock thereon.

5. The fastening device of claim 4, further comprising an elastic member acting on said bracket to bias said bracket over said protuberance when the nut is threaded on the bolt, whereby the nut is locked on the bolt.

6. The fastening device of claim 4, wherein said bracket is pivotably mounted within said nut such that one end extends beyond a peripheral surface of the nut when biased over said protuberance, and wherein said bracket is configured to be pivoted by placement of a tool over the nut such that the bracket is disengaged from the protuberance, whereby the nut is unlocked from the bolt.
